(19) United States
(12) Patent Application Publication
(10) Pub. No.: US 2019/0386591 A1
(43) Pub. Date: Dec. 19, 2019

(54) METHOD FOR DETERMINING THE ROTATIONAL ANGULAR POSITION OF THE ROTOR OF A MULTIPHASE ELECTRIC MACHINE

(71) Applicant: Rolf STROTHMANN, Saarlouis (DE)

(72) Inventor: Rolf STROTHMANN, Saarlouis (DE)

(21) Appl. No.: 16/477,442

(22) PCT Filed: Jan. 9, 2018
(86) PCT No.: PCT/DE2018/100009

§ 371 Date: Jul. 11, 2019

(30) Foreign Application Priority Data
Jan. 12, 2017 (DE) 10 2017 100 515.3

(51) Int. Cl. H02P 6/185; G01B 7/30

(52) U.S. Cl. CPC H02P 6/185; G01B 7/30

(57) ABSTRACT

A method for determining the position of the rotor of a multiphase electric machine with pole windings, the inductances of which are uniquely connected to the rotational angular position of the rotor in the currentless state at least within rotational angular periods. At least one measurement point between pole windings, a measurement signal which depends on the current inductances of the pole windings and which is generated by voltage jumps at a phase conductor input is tapped. Multiple measurement points are provided for tapping a signal, the measurement points being arranged collectively at one and the same phase conductor. For each measurement point, the respective phase conductor with the lowest current operating current is selected.

The invention relates to a method for determining the rotational angular position of the rotor of a multiphase electric machine with pole windings, the inductances of which, in the de-energized state, at least within rotational angular periods, are explicitly connected to the rotational angular position of the rotor wherein, for the determination of the rotational angular position at a measurement point between pole windings, a measurement signal which is dependent upon the instantaneous inductances of the pole windings of the electric machine, and which is generated by a voltage jump at a phase conductor input, is tapped off.

Methods of this type are described in DE 10 2011 008 141 A1 and DE 10 2011 008 756 A1. These methods permit the determination of the rotational angular position of the rotor during the operation of the machine, without the use of sensors, e.g. Hall probes. The measurement of voltage signals and the evaluation thereof are executed during time periods, in which variations in the rotational position of the rotor are negligible.

As a measurement point for the tap-off of voltage signals, in electric machines with star-connected phase conductors, the neutral point is customarily employed. The voltage signal which is available for tapping off on the neutral point incorporates the inductances of all the pole windings of the electric machine.

By means of the present invention, a novel method of the above-mentioned type is provided, characterized in that, for the determination of the rotational angular position, measurement signals are respectively tapped-off at a plurality of measurement points, which are respectively arranged on one and the same phase conductor.

According to the invention, these measurement points permit the determination of a measurement signal which is exclusively dependent upon the inductances of this single phase conductor. Advantageously, an option is thus provided for the selection of a phase conductor which is particularly appropriate for the positional determination of the rotor.

For the determination of the rotational angular position of the rotor, the respective phase conductor is appropriately selected in which the lowest instantaneous operating current is flowing. Advantageously, as a result, any corrupting influences of operating currents upon the inductances of the pole windings can be reduced, and the rotational angular position can be more accurately determined on the basis of a predefined relationship between the inductances of the pole windings, which are influenced by the rotor field, and the rotational angular position.

As a measurement signal, a voltage signal which is divided in accordance with the inductances of the pole windings of the electrical machine, generated by the division of the voltage jump, specifically a potential jump which corresponds to the voltage jump, is preferably tapped-off at the respective measurement point. By the determination of a potential jump of this type, slow-changing voltages on the measurement points, e.g. induced voltages or voltage drops across ohmic resistances, can advantageously be eliminated. From the measurement signals on the various measurement points, a signal which is independent of the inductances of the remaining phase conductors is preferably constituted.

Preferably, for the constitution of the independent signal, a quotient is constituted from the measurement signals which are determined on the various measurement points.

If the phase conductors are star-connected, the plurality of measurement points appropriately includes the neutral point, by way of a measurement point.

The voltage jump is preferably a potential edge of an operating voltage pulse which is applied to the electric machine, specifically a PWM pulse, or a separate measuring voltage pulse, which only influences the operation of the electric machine to a negligible extent.

The electric machine can be a multi-pole machine which comprises, e.g. twelve pole windings and magnet pairs for the constitution of five magnetic periods.

Measurement points in one and the same phase conductor can be such points at which a tap-off is executed by means of a measuring winding, wherein a corresponding measurement signal jump is induced in the measuring winding by the voltage jump.

The invention is further described hereinafter with reference to exemplary embodiments, and to the attached drawings, which relate to said exemplary embodiments. In the drawings:

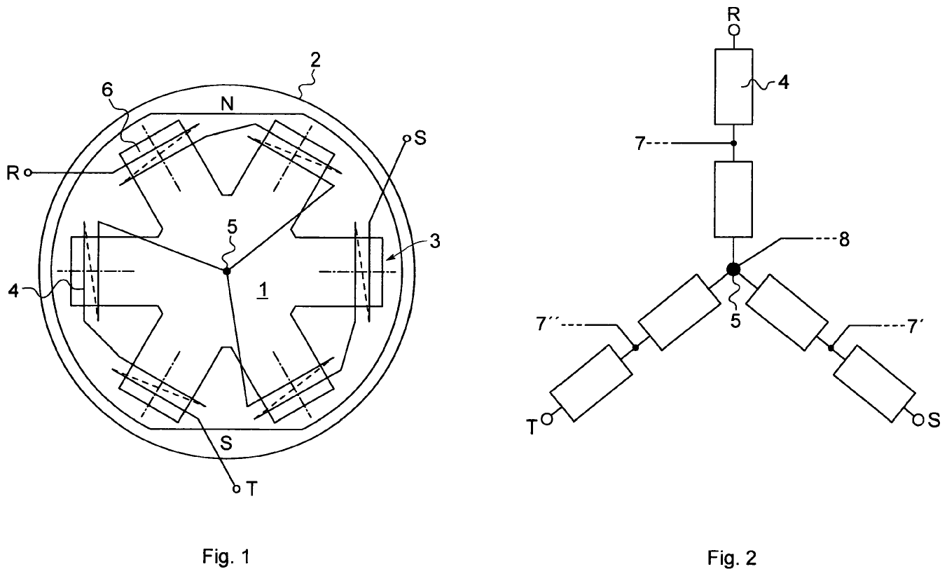

FIG. 1 shows a schematic representation of an electric machine, the rotor position of which is determinable by the method according to the invention,

FIG. 2 shows a schematic representation of the star-connected phase conductors of the electric machine according to FIG. 1,

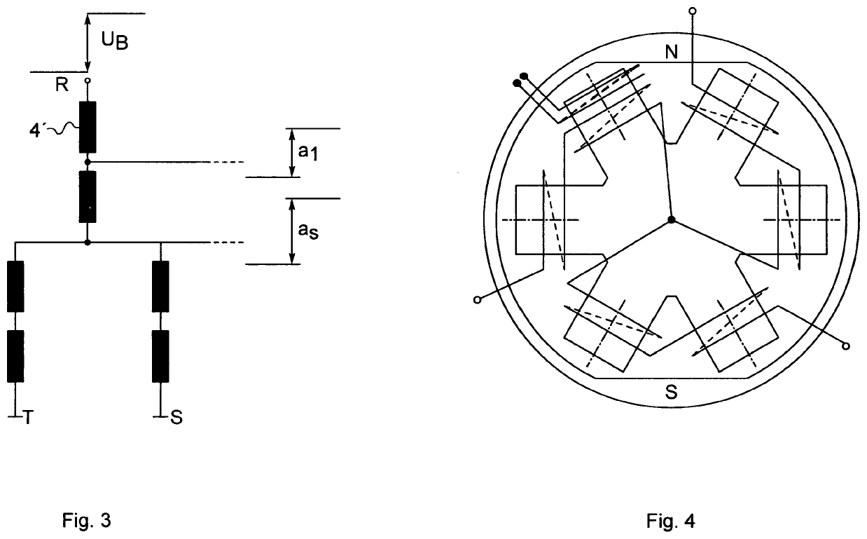

FIG. 3 shows an illustrative representation of the method according to the invention, and

FIG. 4 shows a further schematic representation of an electric machine with a measuring winding.

FIG. 1 shows an electric machine having a stator 1 and a rotor 2, in the present case an external rotor.

In the example represented, the stator 2 comprises six stator poles 3. Series-connected pole windings 4 of adjoining stator poles 3 are respectively constituted by one of the three phase conductors R, S, T, which form a junction at the neutral point 5. The pole windings each comprise one iron core 6.

FIG. 2 shows a separate representation of the phase conductors R, S, T, together with the pole windings 4 of the electric machine. Respectively, between the two pole windings of each phase conductor, a tap-off point 7, 7′ or 7″ is provided for a measuring voltage signal. A further tap-off point 8 for a measuring voltage signal is located on the neutral point 5.

The iron cores 6 of the pole windings 4 of the electric machine are differently magnetized by the magnetic field of the rotor 2, such that different saturation levels of the core material result in different inductances in the pole windings 4. Specifically, the inductance of each pole winding is dependent upon the rotational angular position of the rotor 2. Within two rotational angle regions of 180° respectively, an explicit functional relationship exists in each case between the rotational position of the rotor and the inductance of the pole windings 4.

By way of a departure from FIG. 1, a larger number of magnet pairs for the constitution of magnetic periods, and a larger number of stator poles 3 or phase conductors might be provided. In each case, the inductances of the pole windings within each magnetic half-period are explicitly dependent upon the rotor position.

In the operation of the electric machine as a motor by pulse-width modulation (PWM method), wherein a pulsed voltage, e.g. a battery voltage U_{B}, is alternately applied to the phase conductors R, S, T, potential jumps occur at the tap-off points 5, 7, 7′ and 7″, approximately simultaneously with the edges of the PWM pulses.

The jump amplitude is characteristically determined by the respective voltage divider ratio on the tap-off points. In the event of abrupt voltage variations on the inputs of the phase conductors R, S, T, the voltage divider ratio for the resulting potential jump on the tap-off points is exclusively dependent upon the instantaneous inductances of the pole windings 4. The inductances, in turn, are dependent upon the rotational position of the rotor 2. Depending upon the rotational position of the rotor 2, the magnetic field of the rotor varies the saturation level of magnetization of the iron cores 6, and thus the inductance of the pole windings 4.

FIG. 3 shows a circuit state, in which a battery voltage U_{B} is applied to the phase conductor R. The two other phase conductors S, T are at the ground potential (potential neutral point). At the time of a voltage jump ΔU_{B}, a voltage jump of jump amplitude a_{S} occurs at the neutral point 5. The difference U_{B}− a_{S} relates to the voltage U_{B} as the instantaneous inductance L_{R} of the phase conductor R relates to the sum of the inductance L_{R} of the phase conductor R and the instantaneous inductance L_{S,T} of the parallel circuit of the phase conductors S and T:

$$\frac{{U}_{S} - {a}_{s}}{{U}_{B}} = \frac{{L}_{R}}{{L}_{R} + {L}_{S , T}} \qquad ( 1 )$$

At the tap-off point 7, a voltage signal a₁ is simultaneously tapped-off. The difference U_{B}−a₁ relates to the battery voltage U_{B} as the instantaneous inductance L₁ of the pole winding 4′ of the phase conductor R relates to the sum of the instantaneous inductance L_{R} of the phase conductor R and the instantaneous inductance L_{S,T} of the parallel circuit of the phase conductors S and T:

$$\frac{{U}_{B} - {a}_{1}}{{U}_{B}} = \frac{{L}_{1}}{{L}_{R} + {L}_{S , T}} \qquad ( 2 )$$

If the quotient (U_{B}−a₁)/U_{B} is divided by the quotient (U_{B}−a_{S})/U_{B}, this gives a quotient signal a, which is only dependent upon the inductances L₁,L_{R} of the phase conductor R:

$$a = \frac{{U}_{B} - {a}_{1}}{{U}_{B} - {a}_{s}} = \frac{{L}_{1}}{{L}_{R}} \qquad ( 3 )$$

The quotient signal a, within each magnetic half-period of the rotor field, i.e. in the case described within the second rotational angle region of 180°, is explicitly dependent upon the rotational angle of the rotor, and can thus constitute a measure for the rotational angle of the rotor.

Advantageously, the determination of the quotient signal a permits a determination of the rotor position which is substantially undisturbed by operating currents of the electric machine, on the basis of a predefined functional relationship between the rotor position and the quotient signal a wherein, in each case, that of the phase conductors R, S, T is selected in which the lowest instantaneous operating current is flowing. Consequently, for the inductances of the pole windings in this phase conductor, essentially only the magnetic field (6) of the rotor is critical, and the saturation level of the iron cores, which is critical to the inductances, is only influenced by operating currents to a limited extent.

A voltage jump across a pole winding 4, generated by a voltage jump on a phase conductor input, the amplitude of which is dependent upon the respective inductance of the pole winding, might also be tapped-off by means of the measuring winding 9 represented in FIG. 4. The voltage jump on the pole winding 4 is transferred to the measuring winding 9 by transformation. Such measuring windings 9 might at least be applied to at least one pole winding of each phase conductor such that, in each case, the selectable phase conductor for the purposes of measurement is that in which the lowest operating current of the electrical machine is flowing.

A measurement point for the tap-off of a voltage signal, by way of a departure from the exemplary embodiments described above, might also be provided on a phase conductor having a single winding, wherein the measurement point subdivides the single winding into partial windings. On the grounds of the different spatial arrangement of the partial windings, the ratio of the inductances of the partial windings is dependent upon the rotational position of the rotor.

The above description takes account of the fact that, for inductances of the pole windings in a de-energized state, the magnetic field of the rotor is critical and, accordingly, within each magnetic half-period, an explicit functional relationship exists between the rotational angle of the rotor and the inductances. It is understood that variations in the inductances of the pole windings can also be associated with variations in air gaps which occur during the rotation of the rotor.

In order to reduce the number of lines and/or sources of interference, for example, measurement points, including measuring windings, might be interconnected by means of resistor networks.

The signal processing function described above might be executed within the electric machine, where applicable digitally, wherein the processed signals are routed to a power output stage which is arranged outside the electric machine. For signal processing, a highly-integrated circuit/evaluation unit can be employed, which taps off signals from the measurement points, or optionally via a measuring winding, directly within the motor.

For the supply of an operating voltage to the evaluation unit, an auxiliary coil or a measuring winding itself can be employed, wherein galvanic isolation is simultaneously provided. Provided that not all phases of the electric machine are connected in a common-mode arrangement, operating energy can be transmitted from the electric machine to the evaluation circuit.

The evaluation unit might be designed to cooperate with power output stages, as is customary for the reception of signals from external locators, e.g. resolvers.

Where measuring windings are employed, the evaluation and detection of signals can be optimized by the corresponding interconnection of windings. For example, windings associated with the same rotor position can be connected in series, in order to increase the signal level. In the context of more complex signal processing, signals can be subject e.g. to orthogonalization, wherein sums and differences are constituted. Numbers of windings can be appropriately selected for the requisite scaling.

The preferential selection of the conductor with the lowest operating current can be less advantageous depending upon the design of the electric machine in that, e.g. in machines with strong magnets, the sensitivity of measurement is reduced owing to the high saturation. For the optimization of the measuring result, another selection option can be applied in this case wherein, optionally, an approximately simultaneous evaluation of a plurality of phase conductors can be considered.

1-10. (canceled)

11. A method for determining rotational angular position of a rotor of a multiphase electric machine with pole windings, inductances of which, in a de-energized state, at least within rotational angular periods, are explicitly connected to the rotational angular position of the rotor wherein, the method comprising the steps of: tapping off a measurement signal that is dependent upon instantaneous inductances of the pole windings of the electric machine and is generated by a voltage jump at a phase conductor input for determining the rotational angular position at a measurement point between pole windings; and, for determining the rotational angular position, respectively tapping-off measurement signals at a plurality of measurement points that are respectively arranged on a single phase conductor.

12. The method according to claim 11, wherein the measurement signal is a voltage signal which is divided in accordance with the inductances of the pole windings of the electrical machine, generated by division of the voltage jump, wherein a potential jump which corresponds to the voltage jump is determined on the respective measurement point.

13. The method according to claim 11, including selecting the respective phase conductor with a lowest instantaneous operating current for the measurement points.

14. The method according to claim 11, wherein from the measurement signals on various of the plurality measurement points, a signal is constituted that is independent of the inductances of remaining phase conductors.

15. The method according to claim 14, wherein for the constitution of the independent signal, a quotient is constituted from the measurement signals which are determined on the various measurement points.

16. The method according to claim 11, wherein the phase conductors are star-connected, and the plurality of measurement points include a neutral point as a measurement point.

17. The method according to claim 11, wherein the voltage jump corresponds to a pulse edge of an operating voltage pulse which is applied to the electric machine or to a separate measuring voltage pulse.

18. The method according to claim 17, wherein the operating voltage pulse is a PWM pulse.

19. The method according to claim 11, wherein the electric machine is a multi-pole machine which comprises twelve pole windings and magnet pairs for forming five magnetic periods.

20. The method according to claim 11, including evaluating measuring signals on a plurality of phase conductors for determining the rotational angular position.

21. The method according to claim 11, wherein, both the signal tap-off and the signal processing are executed by an evaluation unit within the electric machine.
